(19) United States
(12) Patent Application Publication
(10) Pub. No.: US 2017/0032687 A1
(43) Pub. Date: Feb. 2, 2017

(54) AUTOMATIC IN/OUT AIRCRAFT TAXIING, TERMINAL GATE LOCATOR AND AIRCRAFT POSITIONING

(71) Applicant: HONEYWELL INTERNATIONAL INC., MORRISTOWN, NJ (US)

(72) Inventors: Andrew Lamkin, Albuquerque, NM (US); David Charles, South Bend, IN (US); Christian Brinkley, Plymouth, MN (US); Stephen Handel, Gilbert, AZ (US)

(73) Assignee: HONEYWELL INTERNATIONAL INC., MORRISTOWN, NJ (US)

(21) Appl. No.: 14/815,762

(22) Filed: Jul. 31, 2015

(51) Int. Cl. G08G 5/06; G08G 5/04; G08G 5/00

(52) U.S. Cl. CPC G08G 5/065; G08G 5/0043; G08G 5/045

(57) ABSTRACT

The systems and methods of the present disclosure generally provide a plurality of onboard and off board positioning, anti-collision, and path following systems that may provide an accurate picture of where each aircraft, proximate a given airport, is located at any given moment in time. The systems and methods may also include determining what obstacles are around each aircraft, and what path the aircraft should follow while taxiing around the airport. Any given aircraft may be automatically navigated along a determined route using at least one engines-off taxiing system.

### BACKGROUND OF THE INVENTION

The present invention generally relates to systems and methods for automatically taxiing aircraft around an airport. More particularly, the present invention relates to systems and methods for dynamically determining taxiing routes for aircraft around an airport.

Airports are becoming more congested. Also, costs associated with operation of airports (e.g., ground crews), and costs associated with operation of aircrafts (e.g., fuel), are increasing.

As aircraft begin to be fitted with systems that enable engine off taxiing (e.g., engines-off taxiing systems) by, for example, directly driving associated landing gear wheels, there is an opportunity to automate airport taxiing processes, terminal gate in procedures, and terminal gate out procedures, to provide workload reduction, human error prevention, and more efficient airport ground operations.

Thus, there is an ongoing need to provide automatic aircraft taxiing route determination on the ground at an airport.

### SUMMARY OF THE INVENTION

In one aspect of the present invention, a system for dynamically determining aircraft route data associated with taxiing aircraft around an airport includes an aircraft location data receiving module stored in a memory that, when executed by a processor, causes the processor to receive aircraft location data, wherein the aircraft location data is representative of respective real-time locations of a plurality of aircraft; an airport geographic map data receiving module stored on a memory that, when executed by a processor, causes the processor to receive airport geographic map data, wherein the airport geographic map data is representative of real-time available aircraft taxiing routes; and an aircraft route data determination module stored on a memory that, when executed by a processor, cause the processor to dynamically determine aircraft route data based, at least in part, on the aircraft location data and the airport geographic map data, during a time period that the plurality of aircraft are taxiing around the airport.

In another aspect of the present invention, a non-transitory computer-readable medium storing computer-executable instructions that, when executed by a processor, cause the processor to dynamically determining aircraft route data associated with taxiing aircraft around an airport includes an aircraft location data receiving module that, when executed by a processor, causes the processor to receive aircraft location data, wherein the aircraft location data is representative of respective real-time locations of a plurality of aircraft and a plurality of ground vehicles proximate the plurality of aircraft; an airport geographic map data receiving module that, when executed by a processor, causes the processor to receive airport geographic map data, wherein the airport geographic map data is representative of real-time available aircraft taxiing routes, real-time availability of runways, and real-time terminal gate/aircraft assignments; and an aircraft route data determination module that, when executed by a processor, cause the processor to dynamically determine aircraft route data based, at least in part, on the aircraft location data and the airport geographic map data.

In yet another aspect of the present invention, a method for dynamically determining aircraft route data associated with taxiing aircraft around an airport includes receiving aircraft location data, wherein the aircraft location data is representative of respective real-time locations of a plurality of aircraft; receiving airport geographic map data, wherein the airport geographic map data is representative of real-time available aircraft taxiing routes; receiving aircraft anti-collision data, wherein the aircraft anti-collision data is representative of obstacles proximate the plurality of aircraft, and wherein the aircraft route data is further based on the aircraft anti-collision data; and an aircraft route data determination module stored on a memory that, when executed by a processor, cause the processor to dynamically determine aircraft route data based, at least in part, on the aircraft location data, the airport geographic map data, and the aircraft anti-collision data.

These and other features, aspects and advantages of the present invention will become better understood with reference to the following drawings, description and claims.

### BRIEF DESCRIPTION OF THE DRAWINGS

FIG. 1 is an automatic in/out aircraft taxiing, terminal gate locator and/or aircraft positioning system according to an exemplary embodiment of the present invention;

FIG. 2A is a block diagram of a computing device for use in an automatic in/out aircraft taxiing, terminal gate locator and/or aircraft positioning system according to an exemplary embodiment of the present invention;

FIG. 2B is a block diagram of modules of a computing device for automatic in/out aircraft taxiing, terminal gate locator and/or aircraft positioning system according to an exemplary embodiment of the present invention of FIG. 2A;

FIG. 2C is a flow diagram of a method for an automatic in/out aircraft taxiing, terminal gate locator and aircraft positioning system according to an exemplary embodiment of the present invention; and

FIG. 3 is a flow diagram of a method for an automatic in/out aircraft taxiing, terminal gate locator and aircraft positioning system according to another exemplary embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

The systems and methods of the present disclosure generally provide a plurality of onboard and off board positioning, anti-collision, and/or path following systems that may provide an accurate picture of where each aircraft, proximate a given airport, is located at any given moment in time. The systems and methods may also include determining what obstacles are around each aircraft, and what path the aircraft should follow while taxiing around the airport. Any given aircraft may be automatically navigated along a determined route using at least one engines-off taxiing system and/or a customary aircraft engine propelled approach. Such automated systems may avoid common problems associated with airports, such as runway incursions, ground collisions, and marshalling errors.

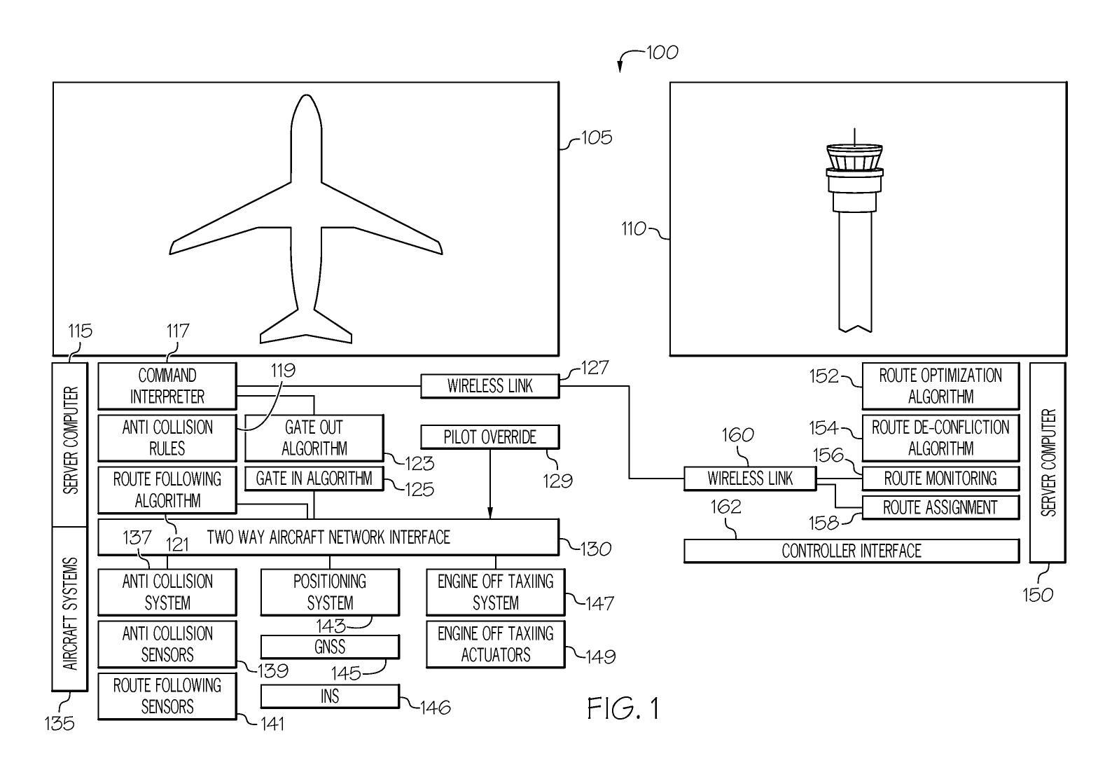

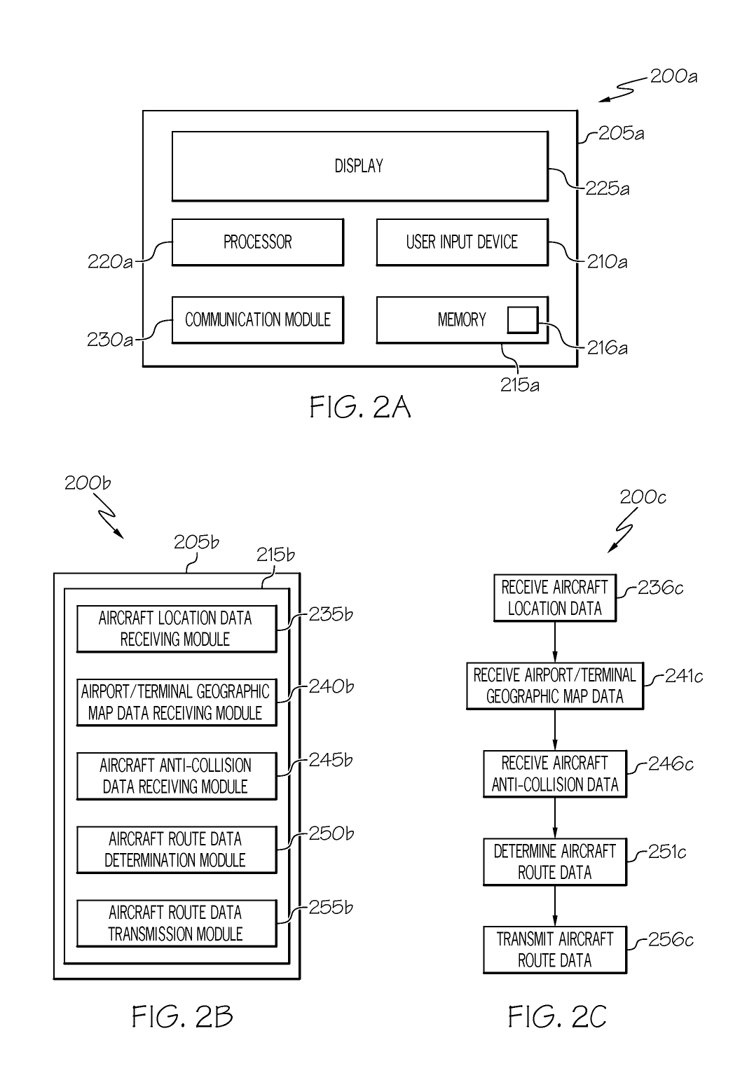

Referring now to FIG. 1, an automatic in/out aircraft taxiing, terminal gate locator and/or aircraft positioning system 100 may include an aircraft 105 proximate an airport terminal 110 (e.g., a control tower, airport control authority, etc.). The aircraft 105 may include an aircraft server computer 115 (e.g., a computing device 200a of FIG. 2A) communicatively coupled to aircraft systems 135 via a two-way aircraft network interface 130. The server computer 115 may include one or more of a command interpreter 117, anti-collision rules 119, a route following algorithm 121, a gate out algorithm 123, a gate in algorithm 125, an aircraft wireless link 127, and a pilot override 129. The command interpreter 117, the anti-collision rules 119, the route following algorithm 121, the gate out algorithm 123 and/or the gate in algorithm 125 may be stored in, for example, a computer-readable storage medium (e.g., memory 215a of FIG. 2A) as computer-readable instructions (e.g., module 216a). Alternatively, the command interpreter 117, the anti-collision rules 119, the route following algorithm 121, the gate out algorithm 123 and/or the gate in algorithm 125 may be, at least partially, embodied in hardware (e.g., an application specific integrates circuit (ASIC), a plurality of electrically interconnected discrete electrical components, a logic circuit, etc.). The aircraft 105, the airport terminal 110, the server computer 115, command interpreter 117, the anti-collision rules 119, the route following algorithm 121, the gate out algorithm 123, the gate in algorithm 125, the aircraft wireless link 127, the pilot override 129, the two way aircraft network interface 130, the aircraft system 135, the anti-collision system 137, the anti-collision sensors 139, the route following sensors 141, the positioning system 143, the GNSS 145, the INS 146, the engines off taxiing system 147 and/or the engines off taxiing actuators 149 may be, for example, as described in commonly assigned U.S. Patent Application Publication Nos. 2014067169 and 2014114557, the entire disclosure of which is incorporated herein by reference.

A processor (e.g., processor 220a of FIG. 2A) may execute a command interpreter 117 to, for example, cause the processor 220a to interpret manually and/or automatically received commands (e.g., a pilot override, wireless link command, a command from an automatic algorithm, etc.). The processor 220a may implement the anti-collision rules 119 to, for example, cause the processor to establish between various inputs, that are received from anti-collision sensors, and anti-collision system outputs (e.g., warnings, aircraft stop commands, etc.). The processor 220a may execute the route following algorithm 121 to, for example, cause the processor to generate output signals to automatically control an aircraft to navigate a determined route. The processor 220a may execute the gate out algorithm 123 to, for example, cause the processor 220a to generate output signals that automatically navigate an aircraft away from a particular airport terminal gate. The processor 220a may execute the gate in algorithm 125 to, for example, cause the processor 220a to generate output signals that automatically navigate an aircraft to a particular airport terminal gate.

The airport terminal 110 (e.g., a control tower, airport control authority, etc.) may include an airport terminal server computer 150 (e.g., a computing device 200a of FIG. 2A) having one or more of a route optimization algorithm 152, a route de-confliction algorithm 154, route monitoring 156, route assignment 158, an airport terminal wireless link 160, and a controller interface 162. The route optimization algorithm 152, the route de-confliction algorithm 154, the route monitoring 156 and/or the route assignment 158 may be stored in, for example, a computer-readable storage medium (e.g., memory 215a of FIG. 2A) as computer-readable instructions (e.g., module 216a). Alternatively, the route optimization algorithm 152, the route de-confliction algorithm 154, the route monitoring 156 and/or the route assignment 158 may be, at least partially, embodied in hardware (e.g., an application specific integrates circuit (ASIC), a plurality of electrically interconnected discrete electrical components, a logic circuit, etc.). The airport terminal server computer 150, the route optimization algorithm 152, the route de-confliction algorithm 154, the route monitoring 156, the route assignment 158, the wireless link 160, and/or the controller interface 162 may be, for example, as described in commonly assigned U.S. Patent Application Publication Nos. 2014067169 and 2014114557, the entire disclosure of which is incorporated herein by reference.

A processor (e.g., processor 220a of FIG. 2A) may execute the route optimization algorithm 152 to, for example, cause the processor 220a to optimize taxiing routes associated with a plurality of aircraft. The processor 220a may execute the route de-confliction algorithm 154 to, for example, cause the processor 220a to resolve conflicts with regard to respective routes related to a plurality of aircraft taxiing around an associated airport. The processor 220a may execute the route monitoring 156 to, for example, cause the processor 220a to monitor a plurality of aircraft while the aircraft are taxiing around an association airport. The processor 220a may implement a route assignment 158 to, for example, assign a respective route to each aircraft proximate an associated airport.

The plurality of onboard and off board positioning, anti-collision, and/or path following systems may provide one or more of an accurate picture of where each aircraft is located proximate an associated airport, what obstacles are around each aircraft, and what path the aircraft should follow while taxiing around an airport. A combination of systems may be installed on any given aircraft, such as the anti-collision system, the engine off taxiing system, and/or the positioning/location system, as well as systems installed in an airport facility, similar to a ground control tower which may, for example, direct and give path assignments to autonomous taxi compatible aircraft. An automatic communications/data transmission system, for communication between associated aircraft systems, ground systems, and an airport tower, may be incorporated.

A system installed in an associated airport ground tower may communicate with one or more aircraft equipped with compatible aircraft systems; and corresponding servers may coordinate, calculate optimal traffic flow patterns, and/or communicate route assignments to aircraft and/or ground equipment. The aircraft and/or ground equipment may automatically navigate a received route assignment based on, for example, autonomous systems on the respective aircraft and/or ground equipment.

In emergency circumstances, airport control tower servers may exercise direct control over connected aircraft, commanding, for example, an engine off taxiing system to mitigate an onboard failure of an autonomous system, or an unexpected condition. Alternatively, or additionally, an aircraft pilot may be provided with an emergency override which may disable the autonomous taxi components entirely, returning the aircraft to manual control.

Referring now to FIG. 2A, a block diagram 200a of a computing device 205a for use in an automatic in/out aircraft taxiing, terminal gate locator and/or aircraft positioning system (e.g., system 100 of FIG. 1) may include a processor 220a, a memory 215a having a module 216a (e.g., a command interpreter 117, anti-collision rules 119, a route following algorithm 121, a gate out algorithm 123, a gate in algorithm 125, a route optimization algorithm 152, a route de-confliction algorithm 154, route monitoring 156 and/or route assignment 158 of FIG. 1), a display 225a, a user input device 210a, and a communication module 230a. The computing device 205a may be configured as, for example, an aircraft server computer 115 and/or an airport terminal server computer 150 of FIG. 1.

Referring now to FIG. 2B, a block diagram 200b of modules of a computing device 205b for automatic in/out aircraft taxiing, terminal gate locator and/or aircraft positioning system may include an aircraft location data receiving module 235b, an airport/terminal geographic map data receiving module 240b, an aircraft anti-collision data receiving module 245b, an aircraft route data determination module 250b, and an aircraft route data transmission module 255b stored, for example, as a set of computer-readable instructions on a memory 215b (e.g., module 216a stored on memory 215a of FIG. 2A). Alternatively, the aircraft location data receiving module 235b, the airport/terminal geographic map data receiving module 240b, the aircraft anti-collision data receiving module 245b, the aircraft route data determination module 250b and/or the aircraft route data transmission module 255b may be, at least partially, embodied in hardware (e.g., an application specific integrates circuit (ASIC), a plurality of electrically interconnected discrete electrical components, a logic circuit, etc.).

Referring now to FIG. 2C, a flow diagram of a method for an automatic in/out aircraft taxiing, terminal gate locator and/or aircraft positioning system 200c may include a processor (e.g., processor 220a of FIG. 2A) that, for example, executes an aircraft location data receiving module 235b to cause the processor 220a to automatically receive aircraft and/or other ground equipment location data from a plurality of aircraft and/or other ground equipment proximate a given airport (block 236c). The aircraft location data may be, for example, automatically derived from a global positioning system (GPS) located on a respective aircraft and/or other ground equipment. Additionally, the aircraft location data may be, for example, representative an intended destination (e.g., in/out airport terminal gate or airport runway) for a respective aircraft.

The processor 220a may further execute an airport/terminal geographic map data receiving module 240b that, for example, may cause the processor 220a to receive airport/terminal geographic map data (block 241c). The airport/terminal geographic map data may be representative of a geographic layout of aircraft in/out terminal gates, airport runways, and airport taxiing paths. Additionally, the airport/terminal geographic map data may be, for example, representative of airport runways that are currently available, airport runways that are currently unavailable, airport taxiing paths that are currently available, and/or airport taxiing paths that are currently unavailable. An aircraft path may be dynamically determined based on taxiways that are opening and closing due to, for example, taxiway maintenance, disabled aircraft, airport/runway congestion, runway crossing avoidance. A dynamic aircraft path determination may include taxiways, runways, and closed runways being used as taxiways.

The processor 220a may also execute, for example, an aircraft anti-collision data receiving module 245b that may cause the processor 220a to receive aircraft anti-collision data from, for example, an aircraft anti-collision system (e.g., aircraft anti-collision system 137 of FIG. 1) and/or aircraft anti-collision sensors (e.g., aircraft anti-collision sensors 138 of FIG. 1) (block 246c). The aircraft anti-collision data may be, for example, representative of obstructions proximate respective aircraft. An aircraft collision avoidance system may include widely spread sensors, and other aircraft/vehicle position received via, for example, a transponder. The associated sensor data may be consolidated into a threat avoidance algorithm. Runway crossings may be dynamically determined, for example, based on runway crossing clearance, arriving/departing aircraft spacing (i.e., a spacing that ATC has set up for arriving and departing aircraft).

The processor 220a may, for example, execute an aircraft route data determination module 250b that may cause the processor 220a to determine aircraft route data based on, for example, the aircraft location data, the airport/terminal geographic map data and/or the aircraft anti-collision data (block 251c). The processor 220a may, for example, execute an aircraft route data transmission module 255b that may cause the processor 220a to transmit aircraft route data to a plurality of aircraft (e.g., aircraft 105 of FIG. 1.) The aircraft route data may be representative of, for example, a dynamically determined route for each aircraft and/or ground vehicle proximate a given airport terminal. Aircraft route data may be representative of a route an aircraft will traverse from a landing runway to a particular airport terminal gate. Alternatively, or additionally, aircraft route data may be representative of a route an aircraft will navigate from a particular airport gate to a takeoff runway. The term “dynamically” is used herein to distinguish from “static.” For example, aircraft route data may be determined initially to reflect an initial set of circumstances (e.g., initial aircraft locations, an initial runway availability, initial terminal gate assignments, etc.), and the aircraft route data may be re-determined in response to a change in any one, or a plurality, of the initial set of circumstances (i.e., the aircraft route data is dynamically determined).

Aircraft route data may be determined dynamically throughout a period of time that an aircraft is navigating between a landing runway and a terminal gate and/or while the aircraft is navigating between a terminal gate and a takeoff runway based on, for example, whether an associated taxiing path becomes unavailable or available, whether a particular runway becomes unavailable or available, whether a terminal gate change occurs, etc. In any event, aircraft route data may be dynamically determined, for example, prior to any given aircraft reaching a point along a path where the aircraft is able to turn in at least two directions.

Processor 220a may dynamically determine aircraft route data based on an optimum criteria (e.g., least amount of time for a given aircraft to navigate a determined path, least amount of total time for all aircrafts proximate a given airport terminal to navigate respective paths, a least amount of potential collisions between associated aircraft, a least number of active runway crossings, etc.). In any event aircraft route data may be dynamically optimized, such that the aircraft route data may be updated any time any aircraft has an opportunity to turn in two or more directions along a respective path.

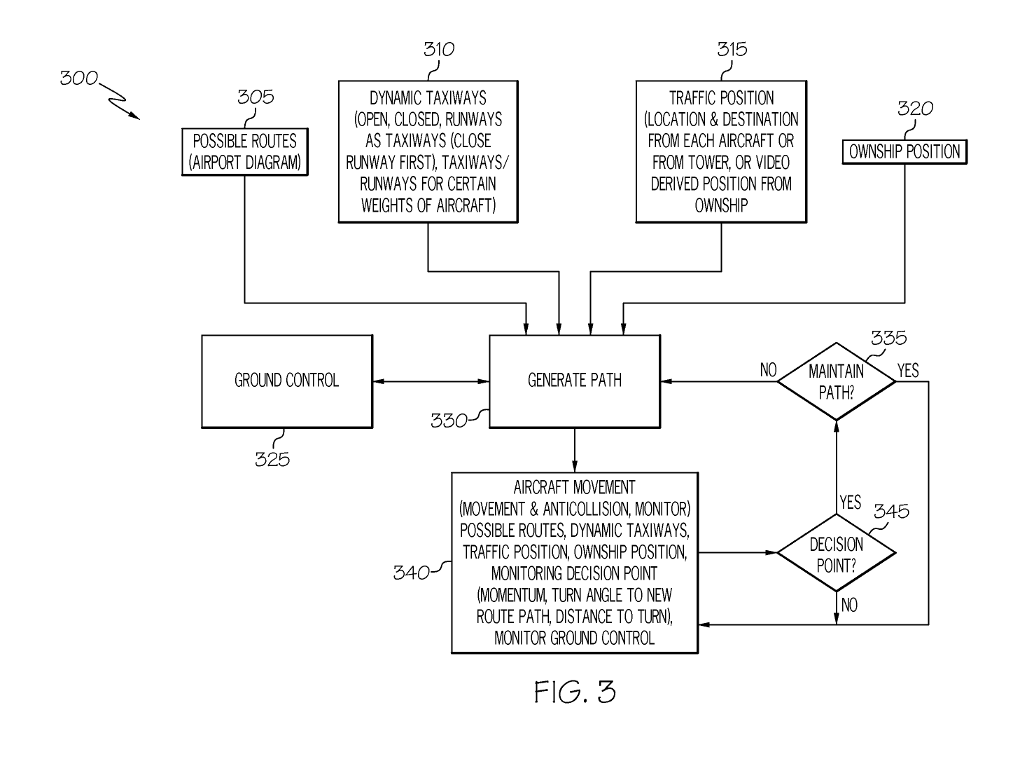

Referring now to FIG. 3, a flow diagram of a method for an automatic in/out aircraft taxiing, terminal gate locator and/or aircraft positioning system 300 may include generating taxiing paths for a plurality of aircraft proximate a terminal of an airport (block 330) based on, for example, possible routes (e.g., an airport layout diagram) (block 305, dynamic taxiways (e.g., open/closed runways as taxiways (or a runway that is currently closed), taxiways/runways for certain weights of aircraft) (block 310), traffic position (location & destination from each aircraft or from tower, or video derived position from ownship) (block 315), ownship position (block 320), ground control (block 325), and aircraft movement (Movement & Anti-collision, monitor possible routes, dynamic taxiways, traffic position, ownship position, monitoring decision point (momentum, turn angle to new route path, distance to turn monitor ground control) (block 340). The method 300 may include a decision whether to maintain current aircraft path(s) (block 335) coinciding with any given decision points (block 345) along given aircraft path(s).

The method 300 may, for example, include two levels of decisions: 1) a routing determination (e.g., generate path); and 2) an optimum route calculation to develop a projected path. The routing determination may be based on current aircraft position, an aircraft destination runway, intersection points on way to runway, taxiways available, and an airport map. Optimum route calculation, to develop a projected path may include aircraft movement and dynamic monitoring of an environment (e.g., aircraft movement), monitoring an aircraft's own projected path, monitoring taxiway/runway status, a GPS position input (e.g., a GPS input of an own aircraft location), position of service vehicles, speed and direction vectors of aircraft and/or service vehicles, position input of other aircraft (e.g., an ATSB or a Radar), constraints for routing of aircraft, aircraft mobility constraints, one direction path segments, limited aircraft agility, aircraft speed and acceleration limitations, passenger comfort, airport constraints, limited routes, closed taxiways/runways, weight limited runways/taxi, decision points, dynamic decision points based on aircraft being at a terminal gate prior to movement, ramp area (e.g., exits to taxiways), route intersections (e.g., taxiway intersections and runway intersections)

Decision points may also be dynamic based on momentum of an aircraft, turn angle to a new route path and/or distance to a new route path. System actions between decision points (e.g., aircraft movement to a runway) may include monitoring an environment proximate at least one aircraft, performing anti-collision calculations and/or performing potential re-routing calculations.

It should be understood, of course, that the foregoing relates to exemplary embodiments of the invention and that modifications may be made without departing from the spirit and scope of the invention as set forth in the following claims.

We claim:

1. A system for dynamically determining an aircraft route at an airport, the system comprising:
an aircraft location data receiving module stored on a memory that, when executed by a processor, causes the processor to receive aircraft location data, wherein the aircraft location data is representative of respective real-time locations of a plurality of aircraft;
an airport geographic map data receiving module stored on a memory that, when executed by a processor, causes the processor to receive airport geographic map data, wherein the airport geographic map data is representative of real-time available aircraft taxiing routes; and
an aircraft route data determination module stored on a memory that, when executed by a processor, cause the processor to dynamically determine the aircraft route based, at least in part, on the aircraft location data and the airport geographic map data, during a time period that the plurality of aircraft are taxiing around the airport.

2. The system of claim 1, further comprising:
an aircraft anti-collision data receiving module stored on a memory that, when executed by a processor, causes the processor to receive aircraft anti-collision data, wherein the aircraft anti-collision data is representative of obstacles proximate the plurality of aircraft, and wherein the aircraft route data is further based on the aircraft anti-collision data.

3. The system of claim 1, further comprising:
an aircraft route data transmission module stored on a memory that, when executed by a processor, causes the processor to transmit aircraft route data to the plurality of aircraft.

4. The system of claim 1, wherein at least one of the plurality of aircraft includes at least one engines-off taxiing system and the at least one aircraft is automatically navigated along a route, using the at least one engines-off taxiing system, based on the aircraft route data.

5. The system of claim 1, wherein the aircraft route data is dynamically determined throughout a period of time that an aircraft is at least one of: navigating between a landing runway and a terminal gate, or while the aircraft is navigating between a terminal gate and a takeoff runway based on at least one of: whether an associated taxiing path becomes unavailable, whether a particular runway becomes unavailable, or whether a terminal gate change occurs.

6. The system of claim 1, wherein the aircraft route data may be dynamically determined prior to any given aircraft reaching a point along a taxiing route where the aircraft is able to turn in at least two directions.

7. The system of claim 1, further comprising:
an aircraft server computer including at least one of: a command interpreter, anti-collision rules, a route following algorithm, a gate in algorithm, a gate out algorithm, a wireless link, or a pilot override.

8. The system of claim 1, further comprising:
aircraft systems including at least one of: anti-collision system, anti-collision sensors, route following sensors, positioning system, GNSS, INS, engine off taxiing system, or engine off taxiing actuators.

9. The system of claim 1, further comprising:
an airport server computer including at least one of: route optimization algorithm, route de-confliction algorithm, route monitoring, route assignment, a wireless link, or a controller interface.

10. A non-transitory computer-readable medium storing computer-executable instructions that, when executed by a processor, cause the processor to dynamically determining an aircraft route at an airport, the non-transitory computer-readable medium comprising:
an aircraft location data receiving module that, when executed by a processor, causes the processor to receive aircraft location data, wherein the aircraft location data is representative of respective real-time locations of a plurality of moving objects in the airport;
an airport geographic map data receiving module that, when executed by a processor, causes the processor to receive airport geographic map data, wherein the airport geographic map data is representative of real-time available aircraft taxiing routes, real-time availability of runways, and real-time terminal gate/aircraft assignments; and
an aircraft route data determination module that, when executed by a processor, cause the processor to dynamically determine the aircraft route based, at least in part, on the aircraft location data and the airport geographic map data.

11. The non-transitory computer-readable medium of claim 10, further comprising:
an aircraft anti-collision data receiving module that, when executed by a processor, causes the processor to receive aircraft anti-collision data, wherein the aircraft anti-collision data is representative of obstacles proximate the plurality of aircraft, and wherein the aircraft route data is further based on the aircraft anti-collision data.

12. The non-transitory computer-readable medium of claim 10, further comprising:
an aircraft route data transmission module that, when executed by a processor, causes the processor to transmit aircraft route data to the plurality of aircraft from an airport server computer.

13. A method for dynamically determining an aircraft route at an airport, the method comprising:
receiving aircraft location data from at least one aircraft system, via a two way aircraft network interface and an aircraft wireless link, wherein the aircraft location data is representative of respective real-time locations of a plurality of aircraft;
receiving airport geographic map data, wherein the airport geographic map data is representative of real-time available aircraft taxiing routes;
receiving aircraft anti-collision data from at least one aircraft anti-collision sensor of an anti-collision system in response to a processor executing anti-collision rules, wherein the aircraft anti-collision data is representative of obstacles proximate the plurality of aircraft, and wherein the aircraft route data is further based on the aircraft anti-collision data; and
an aircraft route data determination module stored on a memory that, when executed by a processor, cause the processor to dynamically determine the aircraft route based, at least in part, on the aircraft location data, the airport geographic map data, and the aircraft anti-collision data.

14. The method of claim 13, wherein the aircraft route data is dynamically determined during a time period that the plurality of aircraft are taxiing around the airport.

15. The method of claim 13, further comprising:
transmitting aircraft route data to the plurality of aircraft from an airport server computer.

16. The method of claim 13, wherein at least one of the plurality of aircraft includes at least one engines-off taxiing system and the at least one aircraft is automatically navigated along a route, using the at least one engines-off taxiing system, based on the aircraft route data.

17. The method of claim 13, wherein the aircraft route data is dynamically determined throughout a period of time that an aircraft is at least one of: navigating between a landing runway and a terminal gate, or while the aircraft is navigating between a terminal gate and a takeoff runway based on at least one of: whether an associated taxiing path becomes unavailable, whether a particular runway becomes unavailable, or whether a terminal gate change occurs.

18. The method of claim 13, wherein the aircraft route data may be dynamically determined prior to any given aircraft reaching a point along a taxiing route where the aircraft is able to turn in at least two directions.

19. The method of claim 13, further comprising:
receiving a pilot override input from a pilot override, wherein the pilot override causes a respective aircraft to revert to pilot control.

20. The method of claim 13, wherein the dynamically determine aircraft route data is further based on an optimum criteria including at least one of: a least amount of time for a given aircraft to navigate a determined path, a least amount of total time for all aircrafts proximate a given airport terminal to navigate respective paths, a least amount of potential collisions between associated aircraft, or a least number of active runway crossings.
